(19) United States
(12) Patent Application Publication
(10) Pub. No.: US 2026/0161703 A1
(43) Pub. Date: Jun. 11, 2026

(54) IMAGE SEARCH APPARATUS, IMAGE SEARCH METHOD, AND NON-TRANSITORY STORAGE MEDIUM

(71) Applicant: NEC Corporation, Minato-ku, Tokyo (JP)

(72) Inventors: Yuji KOBAYASHI, Tokyo (JP); Yoshiaki SAKAE, Tokyo (JP); Hiroki TAGATO, Tokyo (JP); Takashi KONASHI, Tokyo (JP); Jun NISHIOKA, Tokyo (JP); Jun KODAMA, Tokyo (JP); Etsuko ICHIHARA, Tokyo (JP)

(73) Assignee: NEC Corporation, Minato-ku, Tokyo (JP)

(21) Appl. No.: 18/710,238

(22) PCT Filed: Nov. 24, 2021
(86) PCT No.: PCT/JP2021/042875

§ 371 Date: May 15, 2024

(51) Int. Cl. G06F 16/583; G06F 16/538

(52) U.S. Cl. CPC G06F 16/583; G06F 16/538

(57) ABSTRACT

In order to attain the object of improving image search accuracy even in a case where the amount or accuracy of information pertaining to an image is not sufficient, an image search apparatus (1) includes: a generation unit (11) that generates explanatory information for each of images stored in an image storage apparatus; an acquisition unit (12) that acquires a search query; a search unit (13) that searches for an image across the image storage apparatus with use of the search query and the explanatory information; an output unit (14) that outputs a search result obtained by the search unit (13); an input unit (15) that receives input of a determination result from a user with respect to the search result; and an update unit (16) that updates the explanatory information on a basis of the determination result and the search query.

### TECHNICAL FIELD

The present invention relates to a technique for searching for an image.

### BACKGROUND ART

Patent Literature 1 describes an image search system in which an image database is searched on the basis of an inputted search condition. This image search system allows a user to select and classify an image similar to a target image from a set of images obtained by search, and extracts image information pertaining to the classified image from the image database. Further, this image search system uses the extracted image information and the classification information to determine a feature amount related to the target image, and re-searches the image database with use of the determined feature amount.

### CITATION LIST

### Patent Literature 1

Japanese Patent Application Publication Tokukai No. 2000-331009

### SUMMARY OF INVENTION

### Technical Problem

In the image search system described in Patent Literature 1, in a case where image information is not sufficiently stored in the image database, image information pertaining to the classified image cannot be sufficiently extracted. Further, in a case where the accuracy of the image information stored in the image database is not sufficient, the accuracy of the image information extracted pertaining to the classified image is not sufficient. Thus, it is not possible to accurately determine the feature amount related to the target image, and there is a possibility that the search accuracy cannot be improved.

An example aspect of the present invention has been made in view of the above problem, and an example of an object thereof is to provide a technique of improving the accuracy of search for an image even in a case where the amount or accuracy of information pertaining to an image is not sufficient.

### Solution to Problem

An image search apparatus in accordance with an example aspect of the present invention includes: a generation means for generating explanatory information for each of images stored in an image storage apparatus; an acquisition means for acquiring a search query; a search means for searching for an image across the image storage apparatus with use of the search query and the explanatory information; an output means for outputting a search result obtained by the search means; an input means for receiving input of a determination result from a user with respect to the search result; and an update means for updating the explanatory information on a basis of the determination result and the search query.

An image search system in accordance with an example aspect of the present invention includes: a generation means for generating explanatory information for each of images stored in an image storage apparatus; an acquisition means for acquiring a search query; a search means for searching for an image across the image storage apparatus with use of the search query and the explanatory information; an output means for outputting a search result obtained by the search means; an input means for receiving input of a determination result from a user with respect to the search result; and an update means for updating the explanatory information on a basis of the determination result and the search query.

An image search method in accordance with an example aspect of the present invention includes: generating explanatory information for each of images stored in an image storage apparatus; acquiring a search query; searching for an image across the image storage apparatus with use of the search query and the explanatory information; outputting a search result; receiving input of a determination result from a user with respect to the search result; and updating the explanatory information on a basis of the determination result and the search query.

A program in accordance with an example aspect of the present invention is a program for causing a computer to function as an image search apparatus, the program causing the computer to function as: a generation means for generating explanatory information for each of images stored in an image storage apparatus; an acquisition means for acquiring a search query; a search means for searching for an image across the image storage apparatus with use of the search query and the explanatory information; an output means for outputting a search result obtained by the search means; an input means for receiving input of a determination result from a user with respect to the search result; and an update means for updating the explanatory information on a basis of the determination result and the search query.

### Advantageous Effects of Invention

According to an example aspect of the present invention, it is possible to improve the accuracy of search for an image even in a case where the amount or accuracy of information pertaining to an image is insufficient.

### BRIEF DESCRIPTION OF DRAWINGS

FIG. 1 is a block diagram illustrating a configuration of an image search apparatus in accordance with a first example embodiment of the present invention.

FIG. 2 is a flowchart illustrating a flow of an image search method in accordance with the first example embodiment of the present invention.

FIG. 3 is a block diagram illustrating a configuration of an image search system in accordance with the first example embodiment of the present invention.

FIG. 4 is a block diagram illustrating a configuration of an image search system in accordance with a second example embodiment of the present invention.

FIG. 5 is a schematic view for describing details of a moving image and sensor information in accordance with the second example embodiment of the present invention.

FIG. 6 is a flowchart illustrating a flow of an image search method in accordance with the second example embodiment of the present invention.

FIG. 7 is a view for describing explanatory information in accordance with the second example embodiment of the present invention.

FIG. 8 is a schematic view illustrating a specific example of an image search method in accordance with the second example embodiment of the present invention.

FIG. 9 is a schematic view illustrating another specific example of the image search method in accordance with the second example embodiment of the present invention.

FIG. 10 is a schematic view illustrating still another specific example of the image search method in accordance with the second example embodiment of the present invention.

FIG. 11 is a block diagram illustrating a configuration of an image search system in accordance with a third example embodiment of the present invention.

FIG. 12 is a flowchart illustrating a flow of an image search method in accordance with the third example embodiment of the present invention.

FIG. 13 is a diagram illustrating an example of a hardware configuration of the image search apparatus in each of the example embodiments of the present invention.

### DESCRIPTION OF EMBODIMENTS

### First Example Embodiment

A first example embodiment of the present invention will be described in detail with reference to the drawings. The present example embodiment is a basic form of an example embodiment described later.

### Configuration of Image Search Apparatus 1

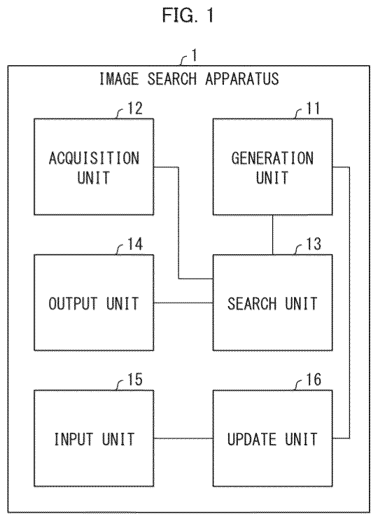

A configuration of an image search apparatus 1 in accordance with the present example embodiment will be described with reference to FIG. 1. FIG. 1 is a block diagram illustrating the configuration of the image search apparatus 1.

As illustrated in FIG. 1, the image search apparatus 1 includes a generation unit 11, an acquisition unit 12, a search unit 13, an output unit 14, an input unit 15, and an update unit 16. The generation unit 11 is an example of a configuration for realizing a generation means recited in the claims. The acquisition unit 12 is an example of a configuration for realizing an acquisition means recited in the claims. The search unit 13 is an example of a configuration for realizing a search means recited in the claims. The output unit 14 is an example of a configuration for realizing an output means recited in the claims. The input unit 15 is an example of a configuration for realizing an input means recited in the claims. The update unit 16 is an example of a configuration for realizing an update means recited in the claims.

The generation unit 11 generates explanatory information for each of images stored in an image storage apparatus. The acquisition unit 12 acquires a search query. The search unit 13 searches for an image across the image storage apparatus with use of the search query and the explanatory information. The output unit 14 outputs a search result obtained by the search unit 13. The input unit 15 receives input of a determination result from a user with respect to the search result. The update unit 16 updates the explanatory information on the basis of the determination result and the search query. The “explanatory information”, the “search query”, and the “determination result” will be specifically described in a flow of an image search method S1 described later.

### Flow of Image Search Method S1

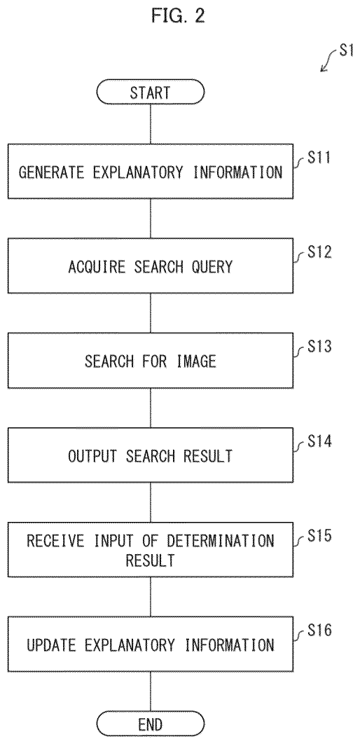

The image search apparatus 1 carries out the image search method S1 in accordance with the present example embodiment. The flow of the image search method S1 will be described with reference to FIG. 2. FIG. 2 is a flowchart illustrating the flow of the image search method S1. As illustrated in FIG. 2, the image search method S1 includes steps S11 to S16.

### Step S11

In step S11, the generation unit 11 generates explanatory information for each of images stored in an image storage apparatus.

Here, the image storage apparatus is an apparatus that stores a plurality of images to be searched for. The image search apparatus 1 is communicably connected to the image storage apparatus via a network, for example. The image to be searched for may be a still image or a moving image. Further, in a case where the image to be searched for is a moving image, the unit of the image to be searched for may be an image segment obtained by dividing a moving image along a time axis. Note that the image storage apparatus may be provided in the image search apparatus 1 as an image storage unit.

Further, the explanatory information is information for explaining each image to be searched for. The explanatory information may be, for example, a pair made up of a key and a value or may be a natural language sentence. However, a form of expression of the explanatory information is not limited to this. For example, the generation unit 11 generates, through analysis of each image, explanatory information based on the result of the analysis. Alternatively, for example, the generation unit 11 may acquire an explanatory text inputted by a user with respect to each image and generate explanatory information on the basis of the acquired explanatory text. In this case, the explanatory text inputted by the user is acquired via an input apparatus or a network. In addition, the generation unit 11 stores, in a memory, the generated explanatory information in association with the image. Since the generation unit 11 generates the explanatory information for each of a plurality of images, the number of explanatory information generated by the generation unit 11 is two or more.

### Step S12

In step S12, the acquisition unit 12 acquires a search query.

The search query includes information for identifying a target image. Specifically, the search query is a query for searching the explanatory information. The search query may be, for example, a pair made up of a key and a value or may be a natural language sentence. However, a form of expression of the search query is not limited to this.

In this step, the acquisition unit 12 may acquire a search query that is inputted by the user via the input apparatus or the network or may acquire a search query that is stored in the memory by reading the search query. Alternatively, the acquisition unit 12 may acquire a search query that is generated by other apparatus or other functional block (not illustrated).

### Step S13

In step S13, the search unit 13 searches for an image across the image storage apparatus with use of the search query and the explanatory information.

For example, the search unit 13 extracts explanatory information at least partially matching the search query among a plurality of pieces of explanatory information generated by the generation unit 11. In addition, the search unit 13 regards, as a search result, an image associated with the extracted explanatory information. Note that the number of images obtained as the search result by the search unit 13 may be one or may be two or more. The number of images obtained as the search result is two or more in a case where the search unit 13 has extracted a plurality of pieces of explanatory information at least partially matching the search query. In this case, the search unit 13 regards, as the search result, the image associated with each of the plurality of pieces of explanatory information extracted.

### Step S14

In step S14, the output unit 14 outputs the search result obtained by the search unit 13. The search result includes one or more images. Here, the output unit 14 may output the search result obtained by the search unit 13 by transmitting the search result to a terminal apparatus of the user. In this case, the terminal apparatus displays the received search result on a display that is connected to the terminal apparatus. Further, the output unit 14 may display the search result obtained by the search unit 13 on a display that is connected to the image search apparatus 1. By outputting the search result in this way, the output unit 14 can present the search result to the user.

### Step S15

In step S15, the input unit 15 receives input of a determination result from a user with respect to the search result.

The determination result is a result of a determination made by the user as to whether each image included in the search result is a target image. As a specific example, the input unit 15 displays, in the vicinity of each image displayed as the search result, a user interface component that allows for selection of “appropriate (a target image)” or “inappropriate (not a target image)”. Note that the user interface component may be displayed on the display that is connected to the image search apparatus 1 or may be displayed on the terminal apparatus of the user. For example, in a case where the search result is displayed on the terminal apparatus of the user, the input unit 15 transmits information indicative of the user interface component to the terminal apparatus, thereby displaying these in the vicinity of each image. Further, the input unit 15 receives input of a determination result of the image in accordance with a selection operation performed by the user with respect to the user interface component. For example, the selection operation performed by the user may be performed with use of an input apparatus connected to the image search apparatus 1 or may be performed on the terminal apparatus of the user. In a case where the user interface component is displayed on the terminal apparatus of the user, the terminal apparatus receives the selection operation performed by the user with respect to the user interface component and transmits information indicative of the selection operation to the image search apparatus 1. The input unit 15 receives the input of the determination result by receiving the information indicative of the selection operation from the terminal apparatus. However, a method of receiving the input of the determination result is not limited to this specific example.

Note that the determination result is not limited to “whether it is a target image or not” and may indicate “a degree of match with a target image”. In this case, the input unit 15 may display a user interface component that allows for selection of three or more levels of options or any numerical values or the like included in a predetermined range (1 to 100 as an example).

### Step S16

In step S16, the update unit 16 updates the explanatory information on the basis of the determination result and the search query. For example, the update unit 16 updates, in accordance with the determination result, a portion that does not match the search query in the explanatory information that partially matches the search query. For example, in a case where a determination result with “appropriate” has been obtained for the image related to the explanatory information, the portion that does not match the search query in the explanatory information is updated so as to match the search query.

### Effect of the Present Example Embodiment

As described above, according to the image search apparatus 1 and the image search method S1 in accordance with the present example embodiment, a configuration is employed in which explanatory information is generated for each of images stored in an image storage apparatus, a search query is acquired, one or more images are searched for across the image storage apparatus with use of the search query and the explanatory information, a search result is outputted, input of a determination result from a user with respect to the search result is received, and the explanatory information is updated on the basis of the determination result and the search query.

According to this configuration, the generation unit 11 generates explanatory information pertaining to an image, and search is carried out with use of the generated explanatory information. Thus, it is possible to accurately carry out search even in a case where the amount or accuracy of information associated with the image in advance is not sufficient. Further, according to this configuration, it is possible to accurately update the explanatory information on the basis of feedback from the user on the search result. As a result, it is possible to carry out search with use of the updated explanatory information. This improves the accuracy of search. As described above, according to this configuration, it is possible to provide a technique for improving the accuracy of image search even in a case where the amount or accuracy of information pertaining to an image is not sufficient.

### Another Aspect of the Present Example Embodiment

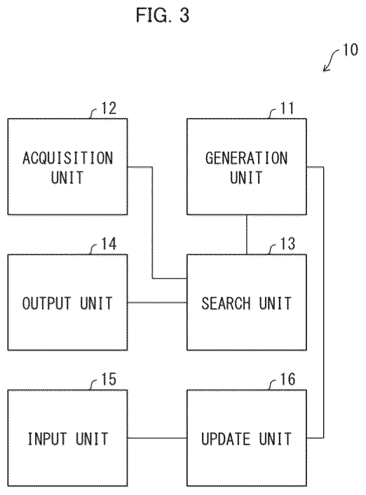

Another aspect of the present example embodiment will be described with reference to FIG. 3. FIG. 3 is a block diagram illustrating a configuration of an image search system 10 in accordance with another aspect. As illustrated in FIG. 3, the image search system 10 includes a generation unit 11, an acquisition unit 12, a search unit 13, an output unit 14, an input unit 15, and an update unit 16. The image search system 10 includes a plurality of physically different apparatuses, and one or more of these units are located dispersedly in a plurality of apparatuses. Details of the configurations and operations of the units are as described above.

### Second Example Embodiment

A second example embodiment of the present invention will be described in detail with reference to the drawings. The same reference numerals are given to constituent elements which have functions identical with those described in the first example embodiment, and descriptions as to such constituent elements are omitted as appropriate.

### Configuration of Image Search System 20

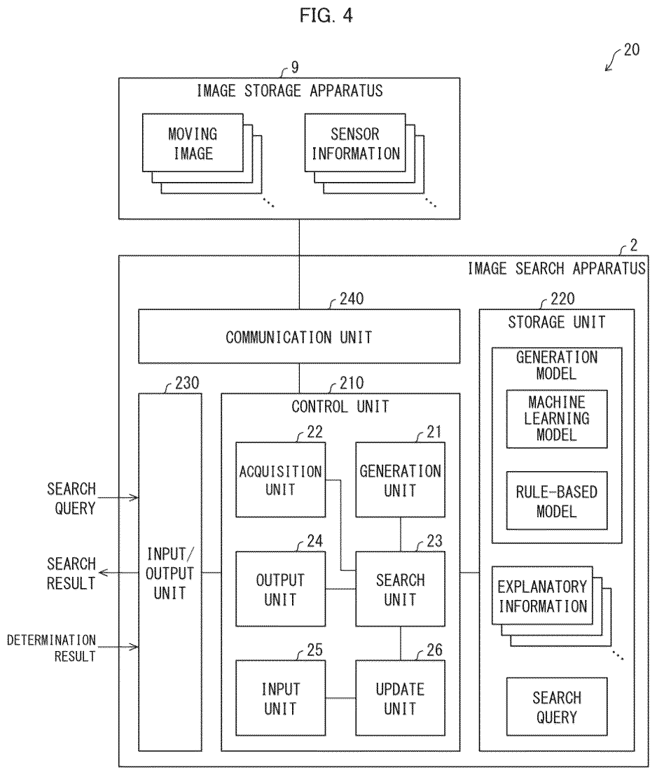

A configuration of an image search system 20 in accordance with the present example embodiment will be described with reference to FIG. 4. FIG. 4 is a block diagram illustrating the configuration of the image search system 20.

As illustrated in FIG. 4, the image search system 20 includes an image search apparatus 2 and an image storage apparatus 9. The image search apparatus 2 includes a control unit 210, a storage unit 220, an input/output unit 230, and a communication unit 240.

### Image Storage Apparatus 9

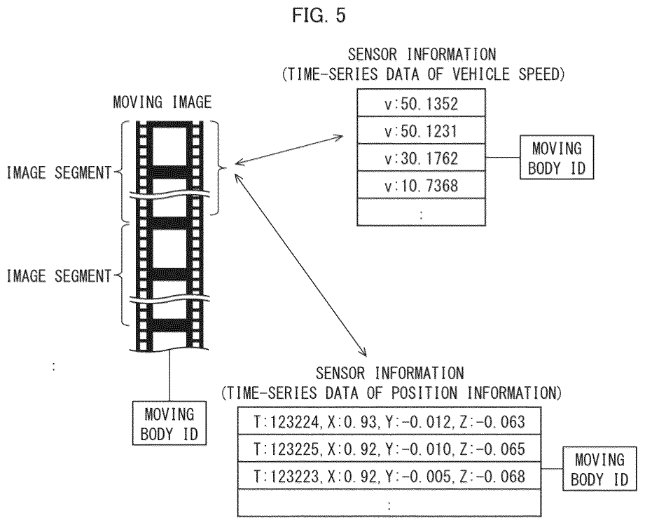

The image storage apparatus 9 stores one or more moving images and one or more types of sensor information. The moving image and the sensor information will be described with reference to FIG. 5. FIG. 5 is a schematic view for describing details of the moving image and the sensor information.

The moving image is an image captured by an image capture apparatus that is mounted on a moving body. For example, the moving body and the image capture apparatus are exemplified respectively by, as an example, an automobile and a drive recorder. However, the moving body and the image capture apparatus are not limited to these. As illustrated in FIG. 5, a moving body ID is associated with the moving image. The moving body ID identifies a moving body on which the image capture apparatus that has captured the moving image is mounted. Further, associated with a frame constituting each moving image is time information pertaining to a time at which the frame has been captured. In addition, the moving image is made up of a plurality of image segments that are obtained by dividing the moving image in accordance with a time axis. The image segments each include a plurality of frames. A temporal length of each image segment is, for example, a length of 10 to 20 seconds, and is not limited thereto. The image segment constituting the moving image is an example of the “image” recited in the claims, and is a unit to be searched for.

The sensor information is information acquired by a sensor that is mounted on a moving body. Examples of the sensor include a vehicle speed sensor, a steering angle sensor, an engine RPM sensor, a positioning sensor, and the like. “Time-series data of vehicle speed” illustrated in FIG. 5 is an example of sensor information acquired by the vehicle speed sensor. “Time-series data of position information” is an example of sensor information acquired by the positioning sensor. However, the type of the sensor and the type of the sensor information are not limited to these. Further, a moving body ID is associated with the sensor information. The moving body ID identifies a moving body on which a sensor that has acquired the sensor information is mounted. Further, time information pertaining to a time at which the sensor information has been acquired is associated with the sensor information.

Further, as illustrated in FIG. 5, the sensor information is associated with the image segment. The image segment and the sensor information can be associated with each other with use of the moving body ID and the time information which are associated respectively with image segment and the sensor information. For example, associated with a certain image segment is time-series data of sensor information that is associated with the same moving body ID and that has been acquired from the start of image capture of the image segment to the end of the image capture thereof.

### Storage Unit 220

The storage unit 220 stores a generation model, explanatory information, and a search query.

The generation model is a model that is generated to receive at least an image as an input and output explanatory information. The generation model includes a machine learning model and a rule-based model.

The machine learning model is, for example, a model that is generated with use of training data so as to receive at least an image segment as an input and output explanatory information. Examples of the machine learning model include, but not limited to, a support vector machine, a decision tree, a random forest, a neural network model, and the like. The machine learning model may be generated by the generation unit 21 described later or may be generated by an external apparatus. The input of the machine learning model may include, in addition to or in place of an image segment itself, sensor information that is associated with the image segment itself.

The rule-based model includes, for example, one or more rules. Each rule includes: a condition related to the sensor information; and explanatory information that is adopted in a case where the condition is satisfied. Note that each rule may include, in addition to or in place of the condition related to the sensor information, a condition related to information obtained by analyzing an image segment. Examples of the information obtained by analyzing an image segment include, but not limited to, a type of a subject, a color thereof, and the like.

The explanatory information is generated and stored by a generation unit 21 which will be described later. The search query is acquired and stored by an acquisition unit 22 which will be described later. Details of the explanatory information and the search query will be described later.

### Input/Output Unit 230

The input/output unit 230 controls input/output to/from the image search apparatus 2. The input/output unit 230 includes, for example, a keyboard, a mouse, a touch pad, a display, and the like.

### Communication Unit 240

The communication unit 240 is connected to a network and controls communications with the image storage apparatus 9. The network to be connected may be, for example, a wireless local area network (LAN), a wired LAN, the Internet, a mobile data communication network, or a combination thereof.

### Control Unit 210

The control unit 210 controls the units that are the storage unit 220, the input/output unit 230, and the communication unit 240 to control the operation of the entire image search apparatus 2. The control unit 210 includes a generation unit 21, an acquisition unit 22, a search unit 23, an output unit 24, an input unit 25, and an update unit 26. The acquisition unit 22, the output unit 24, and the input unit 25 are configured in the same manner as the acquisition unit 12, the output unit 14, and the input unit 15 in the first example embodiment, and thus detailed descriptions thereof will not be repeated.

The generation unit 21 generates explanatory information with use of a generation model. Further, the generation unit 21 generates the explanatory information with use of an image segment and sensor information. The search unit 23 searches, across the image storage apparatus 9, for an image segment that is given explanatory information which at least partially matches a search query. The update unit 26 updates, in accordance with a determination result, a portion that does not match the search query in the explanatory information pertaining to the image segment which has been searched for. Details of, for example, the “search for an image segment that partially matches” and the “update of a portion that does not match” will be described in a flow of an image search method S2 described later.

### Flow of Image Search Method S2

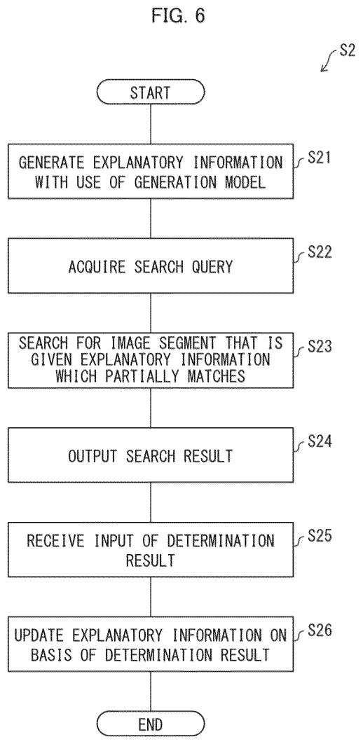

The image search apparatus 2 configured as described above carries out an image search method S2 in accordance with the present example embodiment. The flow of the image search method S2 will be described with reference to FIG. 6. FIG. 6 is a flowchart illustrating the flow of the image search method S2. As illustrated in FIG. 6, the image search method S2 includes steps S21 to S26.

### Step S21

In step S21, the generation unit 21 generates explanatory information for each image segment by a generation model with use of an image segment and sensor information. Specifically, the generation unit 21 inputs the image segment into a machine learning model. In addition, the generation unit 21 inputs, into a rule-based model, the sensor information that is associated with the image segment. Then, the generation unit 21 associates explanatory information outputted from the machine learning model and the rule-based model inion with the image segment and stores the explanatory information in the storage unit 220.

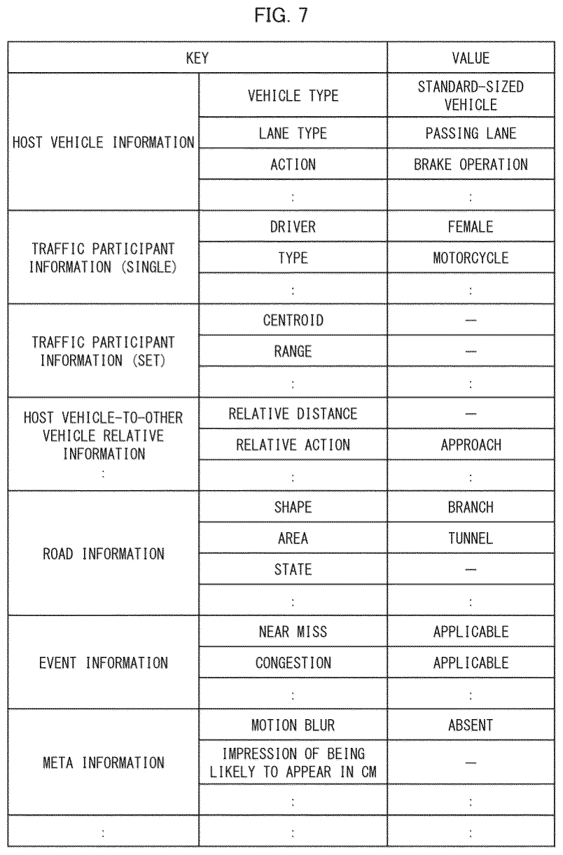

Here, a specific example of the explanatory information generated in step S21 will be described with reference to FIG. 7. FIG. 7 is a view for describing a specific example of the explanatory information. In this specific example, the explanatory information is represented by a pair made up of a key and a value. Note that the explanatory information may include a key that is paired with a value which is an empty value. In the example of FIG. 7, for example, a value of a key “state” included in road information is an empty value. Hereinafter, a pair made up of a key “x” and a value “y” is also described as the value “y” of the key “x”, the value “y” possessed by the key “x”, or the like.

Examples of the type of the key that can be included in the explanatory information include (i) “host vehicle information”, (ii) “traffic participant information (single)”, (iii) traffic participant information (set), (iv) “host vehicle-to-other vehicle relative information”, (v) “road information”, (vi) “event information”, (vii) “meta information”, and the like.

(i) The “host vehicle information” includes a key “vehicle type”, a key “lane type”, a key “action”, and the like key which are related to a host vehicle itself. Note that the “host vehicle” refers to a moving body on which an image capture apparatus that has captured a moving image including the image segment is mounted. The key “vehicle type” indicates the attribute of the host vehicle. In this example, a corresponding value is “standard-sized vehicle”. The key “lane type” indicates one of traveling states of the host vehicle during image capture of an image segment. In this example, a corresponding value is “passing lane”. Examples of other keys indicating the traveling states of the host vehicle include a key “position”, a key “speed”, a key “acceleration”, and the like (which are not illustrated). Further, the key “action” indicates one of actions of the host vehicle during image capture of an image segment. In this example, a corresponding value is “brake operation”. Examples of other values that can be taken by the key “action” also include a value “steering (right turning or left turning)”, a value “merge or diversion/lane change”, a value “passing/overtaking”, and the like (which are not illustrated).

(ii) The “traffic participant information (single)” includes a key “driver”, a key “type”, and the like which are related to traffic participants during image capture of an image segment. Note that the traffic participant is a person, an object, or a vehicle that participates in traffic inside and outside the host vehicle. A value of the key “driver” is “female” in this example. Further, the key “type” indicates the type of the traffic participant other than a driver. In this example, a corresponding value is “motorcycle”. Examples of other values that can be taken by the key “type” include “other vehicle”, “motorcycle”, “bicycle”, “pedestrian”, “animal”, and the like.

### (iii) Traffic Participant Information (Set)

The “traffic participant information (set)” includes a key “centroid”, a key “range”, and the like which are related to a plurality of traffic participants during image capture of an image segment. The key “centroid” indicates a centroid of positions of a plurality of traffic participants. In this example, a corresponding value is an empty value. The key “range” indicates a range in which a plurality of traffic participants are included. In this example, a corresponding value is an empty value.

### (iv) “Host Vehicle-to-Other Vehicle Relative Information”

The “host vehicle-to-other vehicle relative information” includes a key “relative distance”, a key “relative action”, and the like which indicate a relationship between the host vehicle and the other vehicle during image capture of an image segment. The key “relative distance” indicates a relative distance between the host vehicle and the other vehicle. In this example, a corresponding value is an empty value. The key “relative action” indicates a relative action of the host vehicle and the other vehicle. In this example, a corresponding value is “approach”. Examples of other keys indicating a relationship between the host vehicle and the other vehicle include a key “relative speed”, a key “relative acceleration”, and the like (which are not illustrated).

### (v) “Road Information”

The “road information” includes a key “shape”, a key “area”, a key “state”, and the like which are related to a road on which the host vehicle has traveled during image capture of an image segment. The key “shape” indicates the shape of a road. In this example, a corresponding value is “branch”. Examples of other values that can be taken by the key “shape” also include “lane increase/decrease”, “convergence”, “intersection”, and the like. The key “area” indicates an area where a road is present. In this example, a corresponding value is “tunnel”. Examples of other values that can be taken by the key “area” include “lane change prohibition”, “zebra zone”, “safety zone”, “parking lot”, “expressway”, “city area”, “place name”, and the like. The key “state” indicates the state of the road. In this example, a corresponding value is an empty value. Examples of the value that can be taken by the key “state” include values indicating weather conditions including “rainfall” and “snowfall” and also include “pavement” and the like.

### (vi) “Event Information”

The “event information” includes a key “near miss”, a key “congestion”, and the like which are related to an event that has occurred during image capture of an image segment. The key “near miss” indicates whether or not a so-called near-miss event has occurred. In this example, a corresponding value is “applicable”. The key “congestion” indicates whether or not congestion has occurred. In this example, a corresponding value is “applicable”. Examples of other keys that can be included in the “event information” include “accident”, “construction”, “good or poor view”, “good or poor visibility (fog, backlight, heavy rainfall)”, “accident for which the other side is at fault”, and the like.

### (vii) “Meta Information” and the Like

The “meta information” includes a key “motion blur”, a key “impression of being likely to appear in commercial (CM)”, and the like which indicate meta information for an image segment. These keys are information indicative of image features of an image segment regardless of what traffic condition is shown in the image segment. A value of the key “motion blur” is “absent” in this example. Further, a value of the key “impression of being likely to appear in commercial (CM)” is an empty value in this example.

Note that, although FIG. 7 includes an example in which one key has one value, one key may have a plurality of values. In other words, the explanatory information may include a pair made up of one key and a plurality of values. For example, in FIG. 7, the key “action” included in the type “host vehicle information” (hereinafter also referred to as “host vehicle action”) may have a plurality of values “brake operation” and “left turn”. Further, a value corresponding to one key may be represented by a range value. For example, a value (not illustrated) of the key “speed” (hereinafter also referred to as “vehicle speed”) included in the type “host vehicle information” may be “10 to 15 km/h”. Here, “X to Y” represents a range of not less than X and not more than Y, and “km/h” represents a kilometer per hour.

### Step S22

In step S22, the acquisition unit 22 acquires a search query. The operation in this step is substantially similar to the operation in step S12 described in the first example embodiment. However, the search query acquired in this step includes one or more queries. In a case where the explanatory information is represented by a pair made up of a key and a value illustrated in FIG. 7, each query included in the search query is represented by a pair made up of a key and a value. In other words, the search query includes a plurality of pairs each made up of a key and a value. Hereinafter, “a key and a value representing each query included in a search query” is also described as “a key and a value designated by a search query (or a query)” or the like.

In step S23, the search unit 23 searches, across the image storage apparatus 9, for an image segment that is given explanatory information which at least partially matches a search query. For example, in a case where a plurality of queries are included in the search query, the search unit 23 extracts, from the storage unit 220, explanatory information that satisfies at least one or some of the queries. In addition, the search unit 23 regards, as a search result, an image segment that is associated with the extracted explanatory information. For example, assume that a search query includes a first query and a second query. The first query is represented by a pair made up of a first key and a first value, and the second query is represented by a pair made up of a second key and a second value. At this time, the search unit 23 extracts, from the explanatory information stored in the storage unit 220, (i) explanatory information that matches at least the first query (including the pair made up of the first key and the first value) and (ii) explanatory information that matches at least the second query (including the pair made up of the second key and the second value). The explanatory information in (i) includes explanatory information that matches the second query and explanatory information that does not match the second query. The explanatory information that matches the first query but does not match the second query does not completely match the search query and partially matches the search query. The explanatory information in (ii) includes explanatory information that matches the first query and explanatory information that does not match the first query. The explanatory information that matches the second query but does not match the first query does not completely match the search query and partially matches the search query. Note that, in a case where the explanatory information includes a key (a key other than the first key and the second key) which is not designated by the search query, the search unit 23 carries out extraction on the assumption that any value may correspond to such a key.

Here, a determination as to whether or not explanatory information matches each query included in a search query will be described by taking specific examples. A first specific example relates to a query that designates a key (as an example, “vehicle type”) having only one value. As an example, such a query is represented by a pair made up of a key “vehicle type” and a value “standard-sized vehicle”. At this time, in the explanatory information, in a case where the key “vehicle type” has the value “standard-sized vehicle”, the explanatory information matches the query. On the other hand, in the explanatory information, in a case where the key “vehicle type” has a value “mini-vehicle”, the explanatory information does not match the query.

A second specific example relates to a query that designates a key (as an example, “host vehicle action”) that can have a plurality of values. As an example, such a query is represented by a pair made up of a key “host vehicle action” and a value “brake operation”. At this time, in the explanatory information, in a case where the key “host vehicle action” has a plurality of values “brake operation” and “left turn”, the explanatory information matches the query. On the other hand, in the explanatory information, in a case where the key “host vehicle action” has a plurality of values “acceleration” and “left turn”, the explanatory information does not match the query. That is, in the explanatory information, in a case where the key designated by the query has at least a value designated by the query, the explanatory information matches the query. Note that a case where a query is represented by a pair made up of one key and a plurality of values is considered. In this case, in the explanatory information, in a case where the key designated by the query has at least all the values designated by the query, the explanatory information may be regarded as matching the query, and otherwise may be regarded as not matching the query. Alternatively, in the explanatory information, in a case where the key designated by the query has at least one of the plurality of values designated by the query, the explanatory information may be regarded as matching the query. In this case, in the explanatory information, in a case where the key designated by the query does not have any of a plurality of values designated by the query, the explanatory information may be regarded as not matching the query.

In addition, a third specific example relates to a query that designates a key (as an example, “vehicle speed”) which has a value represented by a range value. As an example, such a query is represented by a pair made up of a key “vehicle speed” and a value “10 to 30 km/h”. At this time, in the explanatory information, in a case where the key “vehicle speed” has a value “10 to 15 km/h”, the explanatory information matches the query. Further, in the explanatory information, in a case where the key “vehicle speed” has a value “40 to 50 km/h”, the explanatory information does not match the query. That is, in the explanatory information, in a case where the range value represented by the value of the key designated by the query (hereinafter also referred to as the range value of the explanatory information) is included in the range value designated by the query, the explanatory information matches the query. Further, in a case where there is no overlapping portion between the range value of the explanatory information and the range value designated by the query, the explanatory information does not match the query. Note that the range value of the explanatory information can include both a portion that overlaps the range value designated by the query and a portion that does not overlap the range value designated by the query. For example, included is a case where the range value of the explanatory information is “0 to 15 km/h”, and the range value designated by the query is “10 to 40 km/h”. Such explanatory information may be regarded as matching or may be regarded as not matching.

The determination as to whether or not the explanatory information matches each query included in the search query is not limited to the specific example described above. In addition, the matching condition used in such determination may be optionally designated by the user.

### Step S24

In step S24, the output unit 24 outputs the search result obtained by the search unit 23. The operation in this step is substantially similar to the operation in step S14 described in the first example embodiment. However, the operation in this step differs from the operation in step S14 described in the first example embodiment in that a unit to be outputted as a search result is an image segment.

### Step S25

In step S25, the input unit 25 receives input of a determination result from a user with respect to a search result. The operation in this step is substantially similar to the operation in step S15 described in the first example embodiment. However, the operation in this step differs from the operation in step S15 described in the first example embodiment in that a unit to be received as input of the determination result is an image segment.

### Step S26

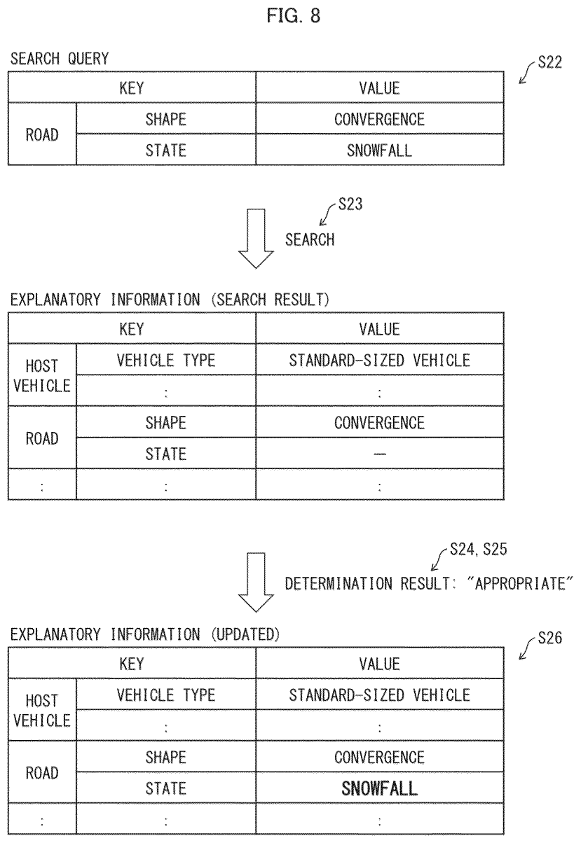

In step S26, the update unit 26 updates, in accordance with a determination result, a portion that does not match the search query in the explanatory information pertaining to the image segment which has been searched for. A specific example of an update process in this step will be described with reference to FIGS. 8 to 10.

### Specific Example 1

FIG. 8 is a schematic view for describing a specific example 1 of an image search method S2. As illustrated in FIG. 8, in this specific example, the search query acquired in step S22 includes that ‘the value of the first key “shape” is “convergence”’ and that ‘the value of the second key “state” is “snowfall”’.

In the explanatory information extracted in step S23, the value of the first key “state” is “convergence”, but the value of the second key “state” is an empty value. Thus, this explanatory information satisfies the search query for the first key and does not satisfy the search query for the second key, and thus partially matches the search query.

In step S24, an image segment associated with this explanatory information is displayed on a display. In addition, the determination result received in step S25 indicates “appropriate”.

In this case, in step S26, the update unit 26 updates the value of the second key “state” that does not match the search query in the explanatory information to “snowfall” so as to match the search query.

In this way, in a case where the determination result indicating that the image segment is appropriate has been obtained, the update unit 26 updates the value of the key that does not match the search query in the explanatory information so as to match the search query.

### Specific Example 2

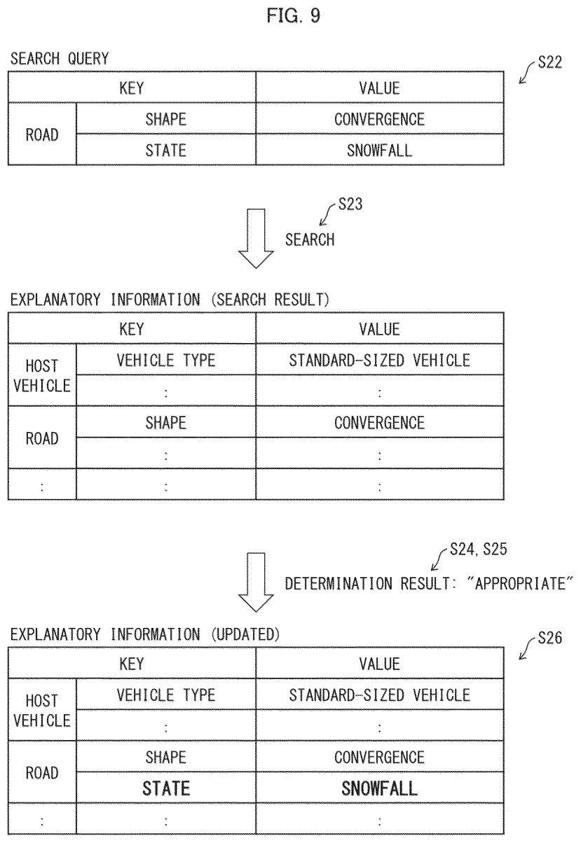

FIG. 9 is a schematic view for describing a specific example 2 of the image search method S2. As illustrated in FIG. 9, a search query acquired in step S22 in this specific example is similar to the search query in the specific example 1.

In the explanatory information extracted in step S23, the value of the first key “state” is “convergence”, but the second key is not included. Thus, this explanatory information satisfies the first query and does not satisfy the second query, and thus partially matches the search query.

In step S24, an image segment associated with such explanatory information is displayed on a display. In addition, the determination result received in step S25 indicates “appropriate”.

In this case, in step S26, the update unit 26 adds the second key “state” to the explanatory information and updates the value of the second key “state” to “snowfall” so as to match the search query.

In this way, in a case where the determination result indicating that the image segment is appropriate has been obtained, the update unit 26 newly adds a key that is not included in the search query, and updates the value of the added key so as to match the search query.

### Specific Example 3

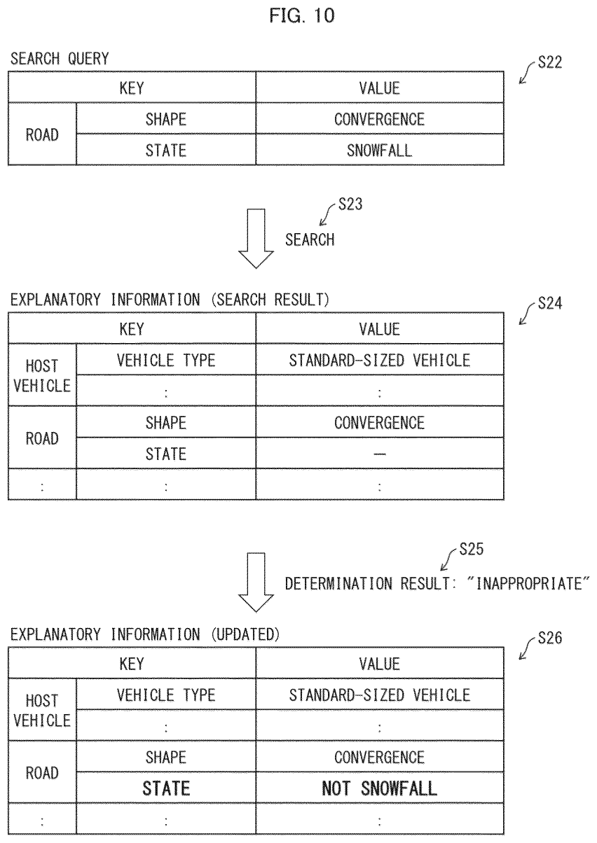

FIG. 10 is a schematic view for describing a specific example 3 of the image search method S2. As illustrated in FIG. 10, a search query acquired in step S22 in this specific example is similar to the search queries in the specific examples 1 and 2.

In the explanatory information extracted in step S23, the value of the first key “state” is “convergence”, and the value of the second key “state” is an empty value. Thus, this explanatory information satisfies the search query for the first key and does not satisfy the search query for the second key, and thus partially matches the search query.

In step S24, an image segment associated with such explanatory information is displayed on a display. In addition, the determination result received in step S25 indicates “inappropriate”.

In this case, in step S26, the update unit 26 updates the value of the second key “state” that does not match the search query in the explanatory information to “not snowfall” so as to negate the search query.

In this way, in a case where the determination result indicating that the image segment is inappropriate has been obtained, the update unit 26 updates the value of the key that does not match the search query in the explanatory information so as to negate the search query. Note that, in this case, in extracting, from the storage unit 220, the explanatory information that satisfies at least a portion of the search query, the search unit 23 does not extract the explanatory information including information that negates the search query.

### Case Where Explanatory Information Completely Matches Search Query

Note that, in step S26, in a case where the explanatory information completely matches the search query and the determination result is “inappropriate”, the update unit 26 may update the explanatory information in such a manner that at least a portion of the explanatory information that matches the search query does not match the search query.

### Effect of the Present Example Embodiment

As described above, the image storage apparatus 9 which is referred to by the image search apparatus 2 and the image search method S2 in accordance with the present example embodiment stores a moving image captured by an image capture apparatus mounted on a moving body and sensor information acquired by a sensor mounted on the moving body. Further, the sensor information is associated with an image segment obtained by dividing a moving image along a time axis. Further, according to the image search apparatus 2 and the image search method S2, in addition to the configuration similar to the configuration in the example embodiment, a configuration is employed in which explanatory information is generated with use of a generation model that has been generated so as to receive an image segment and sensor information as input and output explanatory information.

According to this configuration, the explanatory information is generated with use of the generation model. Thus, it is possible to accurately generate the explanatory information. Further, according to this configuration, the explanatory information is generated with use of the sensor information in addition to the image segment. Thus, it is possible to accurately generate the explanatory information. Therefore, in the present example embodiment, even in a case where information associated with a moving image in advance is absent or insufficient, it is possible to more accurately search for an image segment with use of the explanatory information generated accurately.

Further, according to the image search apparatus 2 and the image search method S2, in addition to the configuration similar to the configuration in the example embodiment, a configuration is employed in which an image that is given explanatory information which partially matches a search query is searched for across the image storage apparatus 9, and a portion that does not match the search query in the explanatory information pertaining to an image which has been searched for is updated in accordance with a determination result.

According to this configuration, it is possible to accurately update a portion that does not match a search query in explanatory information pertaining to an image which has been searched for.

### Other Aspects of the Present Example Embodiment

Other first to eighth aspects obtained by modifying the present example embodiment will be described.

### First Aspect

A first aspect is an aspect in which searching for a target image segment is prioritized. In the first aspect, the output unit 24 and step S24 are modified as below.

In step S24, in a case where the search result includes a plurality of image segments, the output unit 24 outputs the search result in descending order of the degree of search accuracy of the search unit 23.

Here, a specific example of a high degree of search accuracy will be described. As a first specific example, a high degree of search accuracy may mean a high degree of reliability related to a portion that matches a search query in explanatory information. As such a degree of reliability, the degree of reliability outputted together with explanatory information from a machine learning model can be employed. For example, the generation unit 21 associates the explanatory information and the degree of reliability which have been outputted from the machine learning model with an image segment and stores the explanatory information and the degree of reliability in the storage unit 220. In this case, the output unit 24 outputs the image segments in descending order of the degree of reliability which is associated with the portion that matches the search query in the explanatory information.

As a second specific example, a high degree of search accuracy may mean that there is a large portion that matches a search query in explanatory information. For example, in a case where a search query includes three queries, the degree of search accuracy is high in the order of explanatory information that matches all the three queries, explanatory information that matches two queries and does not match one query, and explanatory information that matches one query and does not match two queries.

As a third specific example, a high degree of search accuracy may mean that the weight of a matched query is large. In this case, a plurality of queries included in a search query are assumed to be given a weight. This weight may be designated by a user. Further, this weight may be designated in advance or may be designated together with a search query. For example, assume that a search query includes the following two queries: a query designating a key “host vehicle action”; and a query designating a key “vehicle speed”, and the key “host vehicle action” has a weight larger than the key “vehicle speed”. In this case, the degree of search accuracy is high in the order of explanatory information that matches at least the key “host vehicle action” and explanatory information that does not match the key “host vehicle action”, but matches the key “vehicle speed”.

Note that the “output order” may be realized by, for example, an arrangement order on a display or may be realized by a temporal order. For example, the output unit 24 arranges the plurality of image segments included in the search result in a predetermined direction (e.g., downward from above) in descending order of the degree of search accuracy and displays the plurality of image segments on a display. Further, the output unit 24 repeats displaying a predetermined number of image segments on the display in descending order of the degree of search accuracy, and, upon receiving a determination result for the image segments, displaying, on the display, a predetermined number of image segments with a next higher degree of search accuracy. However, a method of realizing the “output order” is not limited to these.

According to the configuration in the first aspect, the search result is outputted in descending order of the degree of search accuracy. Thus, image segments are presented to the user in the order in which the image segments are outputted. Thus, the user can recognize the image segments in descending order of the degree of search accuracy and can enjoy the merit that a target image segment can be easily found.

### Second Aspect

A second aspect is an aspect in which an improvement in the accuracy of explanatory information is prioritized. In the second aspect, the output unit 24 and step S24 are modified as below.

In step S24, in a case where the search result includes a plurality of image segments, the output unit 24 outputs the search result in ascending order of the degree of search accuracy of the search unit 23.

Here, a specific example of a low degree of search accuracy will be described. As a first specific example, a low degree of search accuracy may mean that the degree in which explanatory information matches a search query is low. For example, in a case where a search query includes three queries, it can be said that the degree of search accuracy is low in the order of explanatory information that matches only one query, explanatory information that matches only two queries, and explanatory information that matches all the three queries. In this case, the output unit 24 outputs the image segments in ascending order of the degree in which explanatory information matches the search query.

As a second specific example, a low degree of search accuracy may mean that there is a small portion that matches a search query in explanatory information. For example, in a case where a search query includes three queries, the degree of search accuracy is low in the order of explanatory information that matches one query and does not match two queries, explanatory information that matches two queries, and explanatory information that matches all the three queries.

As a third specific example, a low degree of search accuracy may mean that the weight of a matched query is small. The weight is as described in the third specific example of a high degree of search accuracy. For example, assume that a search query includes the following two queries: a query designating a key “host vehicle action”; and a query designating a key “vehicle speed”, and the key “vehicle speed” has a weight smaller than the key “host vehicle action”. In this case, the degree of search accuracy is low in the order of explanatory information that matches at least the key “vehicle speed” and explanatory information that does not match the key “vehicle speed”, but matches the key “host vehicle action”.

As a fourth specific example, a low degree of search accuracy may mean that the number of empty values included in explanatory information is large. In this case, the output unit 24 outputs the image segments in descending order of the number of empty values included in explanatory information.

Note that a specific example of the order in which image segments are outputted to the user is similar to the order in the first aspect, and thus detailed description thereof will be omitted.

Here, in step S25, there is a possibility that the user does not input determination results for all the image segments included in the search result and input a determination result(s) for one or some of the image segments which has/have been outputted earlier in the output order. In particular, in a case where the number of image segments included in the search result is large, it is considered that such a tendency is high.

Thus, according to the configuration in the second aspect, the search result is outputted in ascending order of the degree of search accuracy. Thus, image segments are presented to the user in the order in which the image segments are outputted. This allows the user to recognize the image segments in ascending order of the degree of search accuracy. Thus, it is expected that the earlier the order in which image segments are recognized, the likelier it becomes that determination results for the image segments are inputted. As a result, it is possible to receive more determination results for the image segments with a lower degree of search accuracy, and it is thus possible to more accurately update the explanatory information.

### Third Aspect

A third aspect is an aspect in which switching is possible between the first aspect and the second aspect as modes. In the third aspect, the image search apparatus 2 is modified so as to receive input of which mode is to be selected by the user. The image search apparatus 2 operates in the first aspect or the second aspect according to the mode selected by the user.

According to the configuration in the third aspect, the user can enjoy the merit that the user can select whether the user prioritizes a search for a target image segment or prioritizes an improvement in the accuracy of the explanatory information according to the circumstances.

### Fourth Aspect

A fourth aspect is an aspect in which a search result is classified into classification categories. In the fourth aspect, the output unit 24 and step S24 and the input unit 25 and step S25 are modified as below.

In step S24, in a case where a search result includes a plurality of image segments, the output unit 24 outputs the search result in such a manner that the search result is classified into classification categories. For example, the output unit 24 may classify the plurality of image segments into classification categories according to the corresponding pieces of explanatory information. For example, the plurality of image segments included in the search result may be classified into classification categories according to the value of the key “area”. In this case, the key used for the classification may be a key included in the search query or may be a key that is not included in the search query. In addition, the output unit 24 may classify the plurality of image segments according to an image feature (e.g., a type of a subject, a color thereof, or the like) of the image segments. Further, the output unit 24 may classify the plurality of image segments into classification categories with use of a classification model. In this case, the classification model is a model generated by use of machine learning so as to receive image segments as an input and output respective classification categories of the image segments. The classification model may be stored in the storage unit 220 of the image search apparatus 2 or may be stored in an external apparatus. In a case where the classification model is stored in an external apparatus, the image search apparatus 2 uses the classification model by communicating with the external apparatus. In addition, the classification model may be generated by a functional block (not illustrated) of the image search apparatus 2 or may be generated by other apparatus.

Note that, as a method for “outputting in such a manner so as to be classified into classification categories”, there is a method of dividing a display region of a display into a plurality of regions and establishing correspondences between the regions and the classification categories. As another method, for example, there is a method of generating different screens for different classification categories and displaying any of the screens by switching between the screens. Note that the method for “outputting in such a manner so as to be classified into classification categories” is not limited to these methods.

In step S25, the input unit 25 receives input of determination results for each classification. For example, in a case where the image segments are displayed in such a manner that the image segments are classified into a plurality of regions, the input unit 25 may display, for each region, a user interface component for receiving a determination result, and receive an input operation performed on each user interface component. However, the method of “receiving input of determination results for each classification category” is not limited to this method.

According to the configuration in the fourth aspect, the user does not need to individually input determination results for each image segment included in the search result, and can collectively input determination results for each classification category. Thus, it is possible to receive determination results for more image segments, and it is thus possible to more accurately update the explanatory information.

### Fifth Aspect

A fifth aspect is an aspect in which a plurality of determination results are used. In the fifth aspect, the input unit 25 and step S25 and the update unit 26 and step S26 are modified as below.

In step S25, the input unit 25 receives input of a plurality of determination results with respect to a search result. For example, by repeating steps S24 and S25, the image search apparatus 2 may output, again, an image segment for which a determination result has been received and receive a determination result again. In this case, one user inputs a plurality of determination results. For example, the image search apparatus 2 may output a search result to a plurality of terminals in step S24 and receive input of determination results from the plurality of terminals in step S25. In this case, each of a plurality of users inputs a determination result.

In step S26, the update unit 26 updates explanatory information with use of the plurality of determination results. For example, the update unit 26 may use the most common determination result among the plurality of determination results. As a specific example, in a case where three out of five determination results indicate “appropriate”, and two out of the five determination results indicate “inappropriate”, the update unit 26 updates the explanatory information by adopting “appropriate” which is the common determination result. Further, the update unit 26 may carry out weighting for each of the plurality of determination results. For example, in a case where input of a plurality of determination results has been received by repeating steps S24 and S25, the weight may be increased as the order of receiving the input of the determination result is close to the latest.

For example, in a case where a plurality of determination results are received from one user, there is a possibility that the user is confused about whether or not an outputted image segment is a target image segment and changes a determination result each time the user inputs a determination result. In addition, in a case where a determination result is received from a plurality of users, the determination result from a certain user may be different from the determination result from another user. According to the configuration in the fifth aspect, a plurality of determination results are used. Thus, it is possible to accurately update explanatory information as compared with a case where one determination result is used.

### Sixth Aspect

complement is applied to a similar image segment. In the sixth aspect, the update unit 26 and step S26 are modified as below.

Here, as described earlier, the time information and the position information are associated with each image segment of a moving image stored in the image storage apparatus 9. This association is possible by collating a time stamp attached to each frame of the moving image and time-series data of the position information included in the sensor information.

In step S26, the update unit 26 extracts other image segment that is similar in the time information and/or the position information to an image segment targeted for update of explanatory information among images stored in the image storage apparatus 9. In addition, the update unit 26 further updates explanatory information pertaining to the extracted other image. More specifically, the update unit 26 updates the explanatory information pertaining to the extracted other image in the same manner as the explanatory information targeted for update.

Here, as described earlier, the image segment targeted for update of the explanatory information is, for example, an image segment that is given explanatory information which at least partially matches a search query.

For example, in a specific example of the update of the explanatory information with reference to FIG. 8, the value of the key “state” is updated from an empty value to “snowfall”. In this specific example, in the present aspect, the update unit 26 extracts, with respect to an image segment of interest with which explanatory information of interest is associated, other image segment such that a temporal distance and a spatial distance are within their respective threshold values. The extracted other image segment is, for example, an image segment that has been captured, during image capture of the image segment of interest, by other moving body traveling around a moving body that has captured the image segment of interest. Then, the update unit 26 updates the value of the key “state” to “snowfall” also in explanatory information which is associated with the extracted other image segment.

Note that a piece(s) of information associated with each image segment is/are not limited to both the time information and the position information, and may be one selected from the group consisting of the time information and the position information.

In step S26, the update unit 26 may extract other image segment that is similar in traveling direction in addition to time information and position information. For example, even in a case where a moving body travels on the same road in a similar time zone, explanatory information to be given to an image may vary depending on whether a traveling direction is an upbound direction or a downbound direction. By adding a condition in the traveling direction, it is possible to more accurately extract other image segment that is given explanatory information to be similarly updated.

Specifically, in step S26, the update unit 26 identifies the traveling direction of a moving body that has captured an image segment targeted for update of explanatory information. For example, the update unit 26 can identify the traveling direction with use of the time-series data of the position information that is associated with the image segment. The extracted other video segment is, for example, an image segment that has been captured by other moving body traveling in the same direction (upbound or downbound) on the same road as the road on which a moving body that has captured an image segment of interest during image capture of the image segment of interest.

According to the configuration in the sixth aspect, in accordance with a determination result for a certain image segment from the user, it is possible to also update explanatory information that is given to other image segment for which a determination result from the user is not received. Thus, for more image segments, it is possible to more accurately update explanatory information.

### Seventh Aspect

A seventh aspect is an aspect in which a dependency relationship between pieces of explanatory information is taken into consideration. In the seventh aspect, the update unit 26 and step S26 are modified as below.

In the present aspect, explanatory information includes first explanatory information and second explanatory information. The first explanatory information and the second explanatory information have a dependency relationship. Information pertaining to such a dependency relationship is stored in the storage unit 220. For example, in the explanatory information described with reference to FIG. 7, the key “area” is taken as an example of the first explanatory information. In addition, the key “state” is taken as an example of the second explanatory information. For example, in a case where the value of the key “area” is “tunnel”, the value of the key “state” cannot be “rainfall” or “snowfall”. That is, there is a dependency relationship between the key “area” and the key “state”.

In step S26, the update unit 26 updates the explanatory information with use of the dependency relationship between the first explanatory information and the second explanatory information.

For example, in a specific example of the update of the explanatory information with reference to FIG. 8, the value of the key “state” is updated from an empty value to “snowfall”. In this specific example, in a case where the value of the key “area” is “tunnel”, the update unit 26 does not update the value of the key “state” to “snowfall” in consideration of the dependency relationship between the key “area” and the key “state”.

According to the configuration in the seventh aspect, the explanatory information is updated in consideration of the dependency relationship between the first explanatory information and the second explanatory information. Thus, it is possible to more accurately update the explanatory information.

### Eighth Aspect

An eighth aspect is an aspect in which the type of explanatory information targeted for update is limited. In the eighth aspect, the update unit 26 and step S26 are modified as

In the present aspect, explanatory information includes third explanatory information and fourth explanatory information. Further, the generation unit 21 generates third explanatory information with use of a rule-based model. Further, the generation unit 21 generates fourth explanatory information on the basis of a machine learning model or a user input. The rule-based model and the machine learning model are stored in the storage unit 220, and details thereof are as described above. Alternatively, the generation unit 21 may acquire an explanatory text inputted by a user with respect to each image and generate fourth explanatory information on the basis of the acquired explanatory text. Details of the generation of the explanatory information on the basis of the explanatory text inputted by the user are as described in the first example embodiment. Stored in the storage unit 220 is information indicative of either the third explanatory information or the fourth explanatory information according to the type (for example, key) of the explanatory information.

In step S26, the update unit 26 updates the fourth explanatory information without updating the third explanatory information.

Here, the third explanatory information, which is derived on the basis of the rule-based model, has a high degree of objectivity and is highly likely to be clearly defined. Therefore, it can be said that the third explanatory information is information of relatively high accuracy. The fourth explanatory information, which is derived on the basis of the machine learning model or the user input, is likely to be difficult to be clearly defined and is likely to have a low degree of objectivity. Thus, it can be said that the fourth explanatory information is information that has room for improvement in accuracy on the basis of feedback of a determination result.

According to the configuration in the eighth aspect, the third explanatory information of high accuracy is not updated, and the fourth explanatory information that has room for improvement in accuracy is updated. Thus, it is possible to more accurately update the explanatory information.

### Third Example Embodiment

A third example embodiment of the present invention will be described in detail with reference to the drawings. The same reference numerals are given to constituent elements which have functions identical with those described in the second example embodiment, and descriptions as to such constituent elements are omitted as appropriate.

### Configuration of Image Search System 30

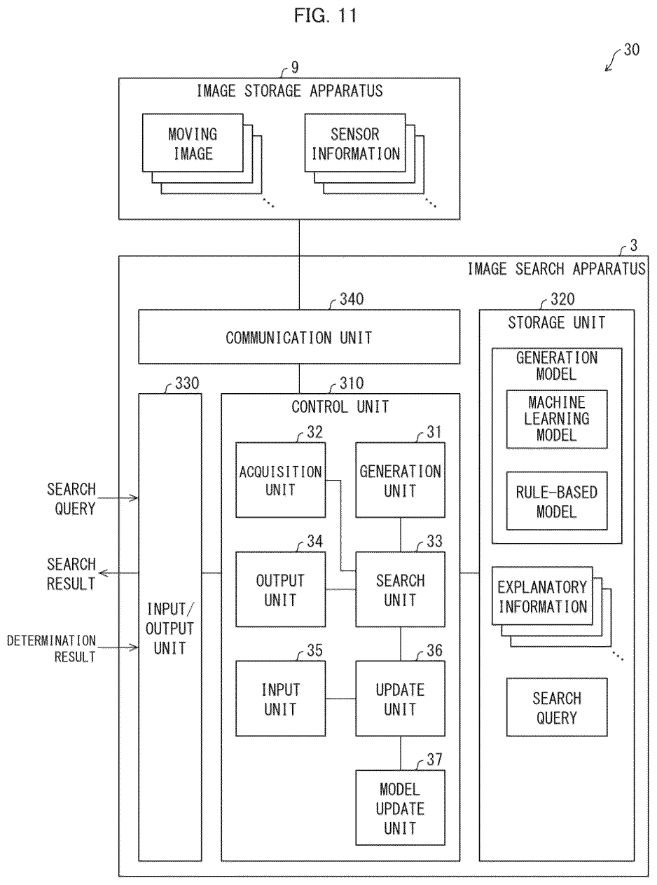

A configuration of an image search system 30 in accordance with the present example embodiment will be described with reference to FIG. 11. FIG. 11 is a block diagram illustrating the configuration of the image search system 30.

As illustrated in FIG. 11, the image search system 30 includes an image search apparatus 3 and an image storage apparatus 9. The image search apparatus 3 includes a control unit 310, a storage unit 320, an input/output unit 330, and a communication unit 340. The image storage apparatus 9 is as described in the second example embodiment. Further, the storage unit 320, the input/output unit 330, and the communication unit 340 are similar to the storage unit 220, the input/output unit 230, and the communication unit 240 described in the second example embodiment, and thus detailed descriptions thereof will not be repeated.

As illustrated in FIG. 11, the control unit 310 includes a generation unit 31, an acquisition unit 32, a search unit 33, an output unit 34, an input unit 35, an update unit 36, and a model update unit 37. Here, the configuration of the model update unit 37 will be described. The other functional blocks are configured in the same manner as in the second example embodiment, and thus detailed descriptions thereof will not be repeated.

The model update unit 37 updates a generation model with use of explanatory information that has been updated by the update unit 36. Details of the update of the generation model will be described in a flow of an image search method S3 described later.

### Flow of Image Search Method S3

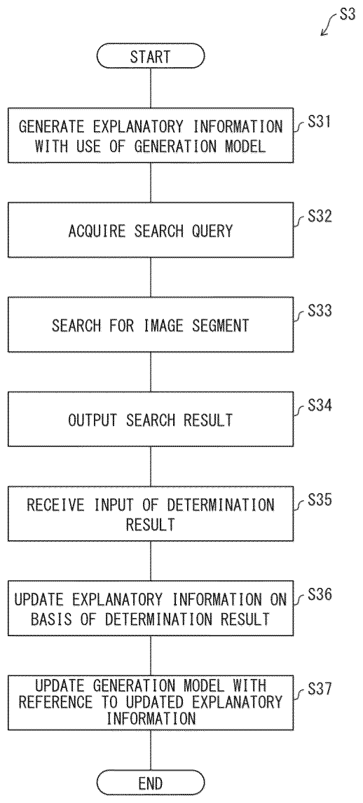

The image search apparatus 3 configured as described above carries out an image search method S3 in accordance with the present example embodiment. The flow of the image search method S3 will be described with reference to FIG. 12. FIG. 12 is a flowchart illustrating the flow of the image search method S3. As illustrated in FIG. 12, the image search method S3 includes steps S31 to S37. The operations in steps S31 to S36 are similar to the operations in steps step S21 to step S26 described in the second example embodiment. Here, the operation in step S37 will be described.

### Step S37

In step S37, the model update unit 37 updates the generation model with use of the explanatory information that has been updated in step S36.

For example, the model update unit 37 uses the updated explanatory information as training data to carry out additional training of the machine learning model included in the generation model. As a specific example, as described with reference to FIG. 8, a case where a value of the key “state” has been updated from an empty value to “snowfall” will be described. In this case, the model update unit 37 carries out additional training of the machine learning model so that the machine learning model outputs a pair made up of the key “state” and the value “snowfall” when a relevant image segment is inputted to the machine learning model.

### Effect of the Present Example Embodiment

The image search apparatus 3 and the image search method S3 in accordance with the present example embodiment employ the configuration in which a generation model is updated with use of explanatory information that has been updated by the update unit 36.

According to this configuration, the generation model is updated so as to output the explanatory information suitable for a determination result from the user. Thus, it is possible to carry out search with use of explanatory information generated with use of an updated generation model, and it is possible to improve the search accuracy.

### Modifications

Each of the second and third example embodiments can be modified as below.

In each of the example embodiments, a configuration may be employed in which the image storage apparatus 9 stores a still image, and a still image is targeted for search. In this case, the still image is an example of the image recited in the claims. In addition, a configuration may be employed in which the image storage apparatus 9 stores a moving image, and a moving image is targeted for search by file, not by image segment. In this case, the file of the moving image is an example of the image recited in the claims.

In each of the example embodiments, a model(s) included in the generation model is not limited to both the machine learning model and the rule-based model and may be only one model selected from the group consisting of the machine learning model and the rule-based model.

In each of the example embodiments, the generation units 21 and 31 may generate explanatory information with use of, in addition to an image segment and sensor information, various types of information that can be associated with the image segment. Examples of such various types of information include, but not limited to, weather information observed in the vicinity of a moving body during image capture of an image segment.

In each of the example embodiments, the explanatory information and/or the search query may be a natural sentence.

In each of the example embodiments, each functional block of the image search apparatuses 2 and 3 may be included in an apparatus that is physically configured as a single unit or may be included dispersedly in a plurality of physically different apparatuses.

### Software Implementation Example

Some or all of functions of the image search apparatuses 1, 2, and 3 can be realized by hardware such as an integrated circuit (IC chip) or can be alternatively realized by software.

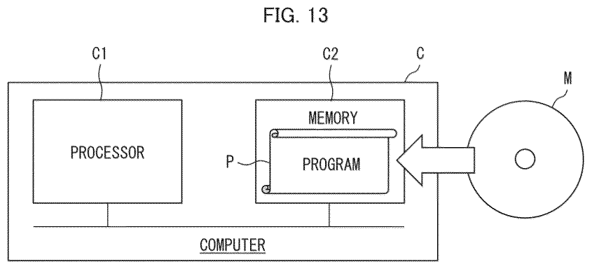

In the latter case, each of the image search apparatuses 1, 2, and 3 is realized by, for example, a computer that executes instructions of a program that is software realizing the foregoing functions. FIG. 13 illustrates an example of such a computer (hereinafter, referred to as “computer C”). The computer C includes at least one processor C1 and at least one memory C2. The at least one memory C2 stores a program P for causing the computer C to operate as each of the image search apparatuses 1, 2, and 3. In the computer C, the processor C1 reads the program P from the memory C2 and executes the program P, so that the functions of the image search apparatuses 1, 2, and 3 are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some of or all of the foregoing example embodiments can also be described as below. Note, however, that the present invention is not limited to the following example aspects.

### Supplementary Note 1

An image search apparatus including:
a generation means for generating explanatory information for each of images stored in an image storage apparatus;
an acquisition means for acquiring a search query;
a search means for searching for an image across the image storage apparatus with use of the search query and the explanatory information;
an output means for outputting a search result obtained by the search means;
an input means for receiving input of a determination result from a user with respect to the search result; and
an update means for updating the explanatory information on a basis of the determination result and the search query.

According to the above-described configuration, even in a case where the amount or accuracy of information pertaining to an image is not sufficient, it is possible to accurately update generated explanatory information and improve the accuracy of search with use of the updated explanatory information.

### Supplementary Note 2

The image search apparatus described in supplementary note 1, wherein:
the generation means is configured to generate the explanatory information with use of a generation model that has been generated so as to receive at least an image as an input and output explanatory information.

According to the above-described configuration, even in a case where information pertaining to an image is absent or insufficient, it is possible to accurately generate explanatory information for that image.

### Supplementary Note 3

The image search apparatus described in supplementary note 2, further including
a model update means for updating the generation model with use of the explanatory information that has been updated by the update means.

According to the above-described configuration, it is possible to more accurately generate explanatory information with use of the updated generation model.

### Supplementary Note 4

The image search apparatus described in any one of supplementary notes 1 to 3, wherein:
the search means is configured to search, across the image storage apparatus, for an image that is given the explanatory information which at least partially matches the search query; and
the update means is configured to update, in accordance with the determination result, a portion that does not match the search query in the explanatory information pertaining to the image which has been searched for.

According to the above-described configuration, it is possible to accurately update a portion that does not match a search query in explanatory information pertaining to an image which has been searched for.

### Supplementary Note 5

The image search apparatus described in any one of supplementary notes 1 to 4, wherein:
the output means is configured to, in a case where the search result includes a plurality of images, output the search result in descending order of a degree of search accuracy of the search means.

According to the above-described configuration, it is possible for the user to enjoy the merit that a target image segment is easily found.

### Supplementary Note 6

The image search apparatus described in any one of supplementary notes 1 to 4, wherein:
the output means is configured to, in a case where the search result includes a plurality of images, output the search result in ascending order of a degree of search accuracy of the search means.

According to the above-described configuration, the user inputs determination results for images in ascending order of the degree of search accuracy. Thus, it is possible to more accurately update explanatory information pertaining to an image with a low degree of search accuracy.

### Supplementary Note 7

The image search apparatus described in any one of supplementary notes 1 to 6, wherein:
the output means is configured to, in a case where the search result includes a plurality of images, output the search result in such a manner that the search result is classified into classification categories; and
the input means is configured to receive input of the determination result for each of the classification categories.

According to the above-described configuration, the user does not need to individually input determination results for each image segment included in the search result, and can collectively input determination results for each classification category. This increases the possibility that determination results for more images are inputted. Thus, it is possible to more accurately update explanatory information.

### Supplementary Note 8

The image search apparatus described in any one of supplementary notes 1 to 7, wherein:
the input means is configured to receive input of a plurality of the determination results with respect to the search result; and
the update means is configured to update the explanatory information on a basis of the plurality of the determination results.

According to the above-described configuration, it is possible to obtain more reliable determination results as compared with a case where one determination result is used. Thus, it is possible to more accurately update explanatory information.

### Supplementary Note 9

The image search apparatus described in any one of supplementary notes 1 to 8, wherein:
time information and/or position information is associated with the respective image stored in the image storage apparatus; and
the update means is configured to further update explanatory information pertaining to other image that is similar in the time information and/or the position information to an image targeted for update of the explanatory information among the images stored in the image storage apparatus.

According to the above-described configuration, it is possible to accurately update explanatory information even for the explanatory information can be accurately updated even for an image for which input of a determination result has not been received.

### Supplementary Note 10

The image search apparatus described in any one of supplementary notes 1 to 9, wherein:
the explanatory information includes first explanatory information and second explanatory information; and
the update means is configured to update the explanatory information with use of a dependency relationship between the first explanatory information and the second explanatory information.

According to the above-described configuration, it is possible to more accurately update the first explanatory information and the second explanatory information between which there is a dependency relationship.

### supplementary Note 11

The image search apparatus described in any one of supplementary notes 1 to 10, wherein:
each of the images stored in the image storage apparatus is an image captured by an image capture apparatus that is mounted on a moving body;
sensor information acquired by a sensor that is mounted on the moving body is associated with each of the images; and
the generation means is configured to generate the explanatory information with use of the image and the sensor information.

According to the above-described configuration, even in a case where the amount or accuracy of information pertaining to an image captured by an image capture apparatus which is mounted on a moving body is not sufficient, it is possible to improve the accuracy of search for the image.

### supplementary Note 12

The image search apparatus described in supplementary note 11, wherein:
the update means is configured to:
   for the image targeted for update of the explanatory information, identify a traveling direction of the moving body during capture of the image targeted for update of the explanatory information; and
   further update explanatory information pertaining to other image that is similar in the traveling direction to the image targeted for update of the explanatory information among the images stored in the image storage apparatus.

According to the above-described configuration, by taking the traveling direction of a moving body into consideration, it is possible to accurately update explanatory information even for an image for which input of a determination result has not been received.

### Supplementary Note 13

The image search apparatus described in supplementary note 11 or 12, wherein:
the explanatory information includes third explanatory information and fourth explanatory information;
the generation means is configured to generate the third explanatory information with use of a rule-based model and generate the fourth explanatory information on a basis of a machine learning model or a user input; and
the update means is configured to update the fourth explanatory information without updating the third explanatory information.

The third explanatory information, which is generated by a rule-based model, has a high degree of objectivity and is highly likely to be clearly defined. In contrast, the fourth explanatory information, which is generated on the basis of a machine learning model or a user input, is likely to be difficult to define or is likely to have a low degree of objectivity. According to the above-described configuration, for the third explanatory information that has a high degree of objectivity and is clearly defined, explanatory information generated by the generation unit is adopted, and the fourth explanatory information that has a low degree of objectivity or is difficult to define is updated. Thus, it is possible to accurately update the explanatory information.

### Supplementary Note 14

An image search system comprising:
a generation means for generating explanatory information for each of images stored in an image storage apparatus;
an acquisition means for acquiring a search query;
a search means for searching for an image across the image storage apparatus with use of the search query and the explanatory information;
an output means for outputting a search result obtained by the search means;
an input means for receiving input of a determination result from a user with respect to the search result; and
an update means for updating the explanatory information on a basis of the determination result and the search query.

According to the above-described configuration, an effect similar to that of supplementary note 1 is brought about.

### Supplementary Note 15

An image search method comprising:
generating explanatory information for each of images stored in an image storage apparatus;
acquiring a search query;
searching for an image across the image storage apparatus with use of the search query and the explanatory information;
outputting a search result;
receiving input of a determination result from a user with respect to the search result; and
updating the explanatory information on a basis of the determination result and the search query.

According to the above-described configuration, an effect similar to that of supplementary note 1 is brought about.

### Supplementary Note 16

A program for causing a computer to function as an image search apparatus, the program causing the computer to function as:
a generation means for generating explanatory information for each of images stored in an image storage apparatus;
an acquisition means for acquiring a search query;
a search means for searching for an image across the image storage apparatus with use of the search query and the explanatory information;
an output means for outputting a search result obtained by the search means;
an input means for receiving input of a determination result from a user with respect to the search result; and
an update means for updating the explanatory information on a basis of the determination result and the search query.

According to the above-described configuration, an effect similar to that of supplementary note 1 is brought about.

### Additional Remark 3

Furthermore, some of or all of the foregoing example embodiments can also be described as below.

An image search apparatus comprising at least one of processor, the at least one processor being configured to carry out:
a generation process of generating explanatory information for each of images stored in an image storage apparatus;
an acquisition process of acquiring a search query;
a search process of searching for an image across the image storage apparatus with use of the search query and the explanatory information;
an output process of outputting a search result obtained in the search process;
an input process of receiving input of a determination result from a user with respect to the search result; and
an update process of updating the explanatory information on a basis of the determination result and the search query.

Note that this image search apparatus can further include a memory. The memory can store a program for causing the processor to carry out the generation process, the acquisition process, the search process, the output process, the input process, and the update process. The program can be stored in a computer-readable non-transitory tangible storage medium.

### REFERENCE SIGNS LIST

10, 20, 30: image search system
1, 2, 3: image search apparatus
9: image storage apparatus
11, 21, 31: generation unit
12, 22, 32: acquisition unit
13, 23, 33: search unit
14, 24, 34: output unit
15, 25, 35: input unit
16, 26, 36: update unit
37: model update unit
210, 310: control unit
220, 320: storage unit
230, 330: input/output unit
240, 340: communication unit
C1: processor
C2: memory
S1, S2, S3: image search method

What is claimed is:

1. An image search apparatus comprising at least one processor, the at least one processor being configured to carry out:
a generation process for generating explanatory information for each of images stored in an image storage apparatus;
an acquisition process for acquiring a search query;
a search process for searching for an image across the image storage apparatus with use of the search query and the explanatory information;
an output process for outputting a search result obtained in the search process;
an input process for receiving input of a determination result from a user with respect to the search result; and
an update process for updating the explanatory information on a basis of the determination result and the search query.

2. The image search apparatus according to claim 1, wherein:
in the generation process, the at least one processor is configured to generate the explanatory information with use of a generation model that has been generated so as to receive at least an image as an input and output explanatory information.

3. The image search apparatus according to claim 2, wherein:
the at least one processor is configured to further carry out:
a model update process for updating the generation model with use of the explanatory information that has been updated in the update process.

4. The image search apparatus according to claim 1, wherein:
in the search process, the at least one processor is configured to search, across the image storage apparatus, for an image that is given the explanatory information which at least partially matches the search query; and
in the update process, the at least one processor is configured to update, in accordance with the determination result, a portion that does not match the search query in the explanatory information pertaining to the image which has been searched for.

5. The image search apparatus according to claim 1, wherein:
in the output process, the at least one processor is configured to, in a case where the search result includes a plurality of images, output the search result in descending order of a degree of search accuracy in the search process.

6. The image search apparatus according to claim 1, wherein:
in the output process, the at least one processor is configured to, in a case where the search result includes a plurality of images, output the search result in ascending order of a degree of search accuracy in of the search process means.

7. The image search apparatus according to claim 1, wherein:
in the output process, the at least one processor is configured to, in a case where the search result includes a plurality of images, output the search result in such a manner that the search result is classified into classification categories; and
in the input process, the at least one processor is configured to receive input of the determination result for each of the classification categories.

8. The image search apparatus according to claim 1, wherein:
in the input process, the at least one processor is configured to receive input of a plurality of the determination results with respect to the search result; and
in the update process, the at least one processor is configured to update the explanatory information on a basis of the plurality of the determination results.

9. The image search apparatus according to claim 1, wherein:
time information and/or position information is associated with the respective image stored in the image storage apparatus; and
in the update process, the at least one processor is configured to further update explanatory information pertaining to other image that is similar in the time information and/or the position information to an image targeted for update of the explanatory information among the images stored in the image storage apparatus.

10. The image search apparatus according to claim 1, wherein:
the explanatory information includes first explanatory information and second explanatory information; and
in the update process, the at least one processor is configured to update the explanatory information with use of a dependency relationship between the first explanatory information and the second explanatory information.

11. The image search apparatus according to claim 1, wherein:
each of the images stored in the image storage apparatus is an image captured by an image capture apparatus that is mounted on a moving body;
sensor information acquired by a sensor that is mounted on the moving body is associated with each of the images; and
in the generation process, the at least one processor is configured to generate the explanatory information with use of the image and the sensor information.

12. The image search apparatus according to claim 11, wherein:
in the update process, the at least one processor is configured to:
for the image targeted for update of the explanatory information, identify a traveling direction of the moving body during capture of the image targeted for update of the explanatory information; and
further update explanatory information pertaining to other image that is similar in the traveling direction to the image targeted for update of the explanatory information among the images stored in the image storage apparatus.

13. The image search apparatus according to claim 11, wherein:
the explanatory information includes third explanatory information and fourth explanatory information;
in the generation process, the at least one processor is configured to generate the third explanatory information with use of a rule-based model and generate the fourth explanatory information on a basis of a machine learning model or a user input; and
in the update process, the at least one processor is configured to update the fourth explanatory information without updating the third explanatory information.

14. (canceled)

15. An image search method comprising:
generating explanatory information for each of images stored in an image storage apparatus;
acquiring a search query;
searching for an image across the image storage apparatus with use of the search query and the explanatory information;
outputting a search result;
receiving input of a determination result from a user with respect to the search result; and
updating the explanatory information on a basis of the determination result and the search query.

16. A computer-readable non-transitory storage medium storing a program for causing a computer to function as an image search apparatus, the program causing the computer to carry out:
a generation process for generating explanatory information for each of images stored in an image storage apparatus;
an acquisition process means for acquiring a search query;
a search process means for searching for an image across the image storage apparatus with use of the search query and the explanatory information;
an output process for outputting a search result obtained in by the search process;
an input process for receiving input of a determination result from a user with respect to the search result; and
an update process for updating the explanatory information on a basis of the determination result and the search query.
